(19) United States
(12) Patent Application Publication
(10) Pub. No.: US 2008/0024163 A1
(43) Pub. Date: Jan. 31, 2008

(54) PROGRAMMABLE LOGIC DEVICE

(75) Inventor: Shin'ichi MARUI, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/683,563

(22) Filed: Mar. 8, 2007

(30) Foreign Application Priority Data
Mar. 14, 2006 (JP) 2006-068800

(51) Int. Cl. G06F 7/38

(52) U.S. Cl. 326/39

(57) ABSTRACT

Provided is a programmable logic device which increases the speed of switching the functions of a reconfigurable core by high-speed configuration data transfer. The programmable logic device includes: a configuration data storage memory which stores configuration data transferred from the outside of the programmable logic device; a reconfigurable core which changes its function according to the configuration data stored in the configuration data storage memory; at least one IO terminal which transfers data from the outside of the device; and a data transfer bus which connects the IO terminal with the configuration data storage memory, and which is dedicated to configuration data transfer.

### BACKGROUND OF THE INVENTION

(1) Field of the Invention

The present invention relates to programmable logic devices and, more particularly to an LSI having a reconfigurable core.

(2) Description of the Related Art

Advances in LSI integration scale have put SoCs (Systems on Chip) to practical use, which is the idea of integrating all elements of an electronic system into a single chip. SoCs achieve their versatility by means of programmable devices including a CPU and a DSP; a data bus connecting the devices together; a data memory, and the like. SoCs also provide excellent performance by means of a hard block. Since enormous expenses are required for the research and development of SoCs, it is indispensable to apply one SoC to various application programs. However, the hard block is designed for a specific application program, with the result that each SoC becomes an LSI which is limited to a specific use, in spite of the versatile devices included therein.

With respect to the above technical problem, there are new ideas of making the hard block more versatile while balancing performance and versatility. One of the ideas is that a reconfigurable core typified by FPGAs is employed instead of a hard block. A reconfigurable core, although inferior to a hard block, is superior by one or more orders of magnitude to DSPs in performance. Furthermore, although functions are statically switched in a conventional reconfigurable core, dynamic switching has been achieved, thereby offering more versatility. In addition, a reconfigurable core capable of switching its functions dynamically is smaller in size than a reconfigurable core switching its functions statically.

If a reconfigurable core is employed instead of a hard block, the size difference between them has to be considered. Since a reconfigurable core has a size one or more orders of magnitude larger than a hard block, performance per area has to increase in order to obtain an LSI with a performance equivalent to a conventional SoC. Specifically, it is desirable that an LSI having a reconfigurable core switches the functions of a single reconfigurable core dynamically one after another so as to offer performance equivalent to an LSI having a plurality of hard blocks.

The technology of dynamically changing the function of a reconfigurable core has already been established. The future challenge, therefore, is how to switch the reconfigurable core functions quickly, and by extension, how to increase the number of function switchings.

In order to change the function of a reconfigurable core, configuration data, which is a kind of a program, has to be downloaded to the reconfigurable core. If the configuration data is stored inside the LSI, the functions are switched at a high speed. On the other hand, if the configuration data is stored outside the LSI, the function switching becomes tremendously longer due to data transfer originating from the outside of the LSI.

In order to increase the speed of switching the functions of a reconfigurable core, various techniques have been proposed, among which the configuration data for switching the functions is stored in a large-scale memory inside the LSI such that parallel configuration is employed for quick switching (e.g. refer to Japanese Laid-Open Patent Application No. H10-285014).

As disclosed in Japanese Laid-Open Patent Application No. H10-285014, if plural pieces of configuration data are always stored inside the LSI so as to overcome the size disadvantage of a reconfigurable core compared to a hard block, this technique might encourage the size disadvantage, contrary to expectation. Also, in order to make the most of the merits of a reconfigurable core, the problem is that all the configuration data stored inside the LSI causes the configuration contents to be fixed. In addition, simply placing the memory which stores the configuration data outside the LSI causes the time required for transferring the configuration data to be longer, with the result that high-speed function switching of the reconfigurable core becomes difficult.

### SUMMARY OF THE INVENTION

In light of the situation described above, an object of the present invention is to increase the speed of switching the functions of a reconfigurable core, with a minimum of configuration data stored in a memory inside an LSI, by transferring the configuration data at a high speed.

In order to overcome the aforementioned problem, a programmable logic device according to the present invention includes: a configuration data storage memory which stores configuration data transferred from the outside of the programmable logic device; a reconfigurable core which changes its function according to the configuration data stored in the configuration data storage memory; at least one IO terminal which transfers data from the outside of the device; and a data transfer bus which connects the IO terminal with the configuration data storage memory, and which is dedicated to configuration data transfer.

According to this configuration, the data transfer bus dedicated to configuration data transfer allows configuration data to be transferred to the configuration data storage memory at a higher speed without the influence of data transfer between the circuit blocks in the programmable logic device which are not involved in the configuration data transfer.

The programmable logic device may further include: a CPU; a data memory which stores application data which is different from the configuration data; an interface circuit which transfers data from the outside of the programmable logic device; a general-purpose bus which connects the CPU, the data memory, and the interface circuit together; a memory control block which controls access to the configuration data storage memory; a first clock line which supplies clock signals to each of the general-purpose bus, the CPU, the data memory, and the interface circuit; and a second clock line which is different from the first clock line, and which supplies clock signals to both of the configuration data storage memory and the memory control block.

According to this configuration, since the clock line connected to the circuit block group which stores configuration data into the configuration data storage memory is different from the clock line of the other circuit blocks, configuration data transfer and the function switching can be performed consistently at an appropriate speed and at the right timing, without the influence of the operations (at low speed or halted) of the other circuit blocks in the programmable logic device.

Alternatively, the programmable logic device may further include: a CPU; a data memory which stores data which is different from the configuration data; an interface circuit which transfers data from the outside of the programmable logic device; a general-purpose bus which connects the CPU, the data memory, and the interface circuit together; a memory control block which controls access to the configuration data storage memory; a first power line which supplies power to the general-purpose bus, the CPU connected to the general-purpose bus, the data memory, and the interface circuit; and a second power line which is different from the first power line, and which supplies power to the configuration data storage memory and the memory control block.

According to this configuration, power is supplied to the circuit block group which stores configuration data in the configuration data storage memory through a power supply system different from a power supply system for the other circuit blocks. This allows configuration data to be transferred to the configuration data storage memory even if power to the other circuit blocks is turned off. Therefore, it becomes possible that configuration data is downloaded to the reconfigurable core immediately after a restart of the power supply to the other circuit blocks, thereby switching the functions at a high speed.

Further alternatively, the programmable logic device may further include: a CPU; an application data storage memory which is different from the configuration data storage memory, and which stores application data and another configuration data, both of which are different from the configuration data, the application data being data to be accessed by the CPU or the reconfigurable core, and the another configuration data being data for changing the function of the reconfigurable core; and a connection switching unit which switches connection of the reconfigurable core either to the configuration data storage memory or the application data storage memory.

According to this configuration, the free space of the application data storage memory inside the programmable logic device becomes available to store configuration data, thereby holding a larger amount of configuration data inside the LSI without increasing the memory capacity to store configuration data. A larger amount of configuration data held inside the LSI reduces the number of data transfers with the outside of the programmable logic device, thereby allowing the switching of the functions at a higher speed.

Still further alternatively, the programmable logic device may further include: a CPU and a data memory which stores application data which is different from the configuration data, wherein the programmable logic device may further include a bus control unit which controls the data transfer bus so that the data transfer bus is dedicated to configuration data transfer at least between the IO terminal and the configuration data storage memory so as to transfer configuration data therebetween when the configuration data transfer is requested.

According to this configuration, even without a data transfer bus dedicated to connect the IO terminal and the configuration data storage memory together, configuration data is transferred to the configuration data storage memory through the general-purpose data transfer bus. Furthermore, when a configuration data transfer is requested, the bus control unit controls the data transfer bus so that the configuration data is transferred exclusively at least between the IO terminal and the configuration data storage memory of the data transfer bus, thereby achieving a high speed configuration data transfer equivalent to the case when the dedicated data transfer bus is provided.

As has been described above, the programmable logic device according to the present invention, which includes the data transfer bus dedicated to transfer configuration data, transfers configuration data to the configuration data storage memory at a higher speed without the influence of data transfer between the circuit blocks in the programmable logic device which are not involved in the configuration data transfer.

### FURTHER INFORMATION ABOUT TECHNICAL BACKGROUND TO THIS APPLICATION

The disclosure of Japanese Patent Application No. 2006-068800 filed on Mar. 14, 2006 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a functional block diagram showing a configuration example of an LSI according to a first embodiment;

FIG. 2 shows details of a configuration of a memory control unit;

FIG. 3 is a functional block diagram showing another configuration example of the LSI according to the first embodiment;

FIG. 4 is a functional block diagram showing a configuration example of an LSI according to a second embodiment;

FIG. 5A, FIG. 5B, and FIG. 5C each show the timing of configuration data transfer, decryption, and decoding by way of an example;

FIG. 6 is a functional block diagram showing another configuration example of the LSI according to the second embodiment;

FIG. 7 is a functional block diagram showing a configuration example of an LSI according to a third embodiment;

FIG. 8A and FIG. 8B each show the timing of configuration data transfer, decryption, decoding, and power-off, by way of an example;

FIG. 9 is a functional block diagram showing a configuration example of an LSI according to a fourth embodiment;

FIG. 10 is a functional block diagram showing a configuration example of an LSI according to a fifth embodiment; and

FIG. 11 shows the timing of processing performed when a configuration data storage memory is a dual port memory, by way of an example.

### DESCRIPTION OF THE PREFERRED EMBODIMENTS

A programmable logic device (hereinafter referred to as “LSI”) according to embodiments of the present invention will be described with reference to the drawings.

Definitions are given for a reconfigurable core and configuration data, which are principal elements of the LSI according to the present invention. The term reconfigurable core means a functional block capable of changing its function as appropriate by switching the connection between a plurality of logic elements included therein. The term configuration data means a program or data for specifying the connection between the logic elements of the reconfigurable core so as to switch the functions.

### (1) First Embodiment

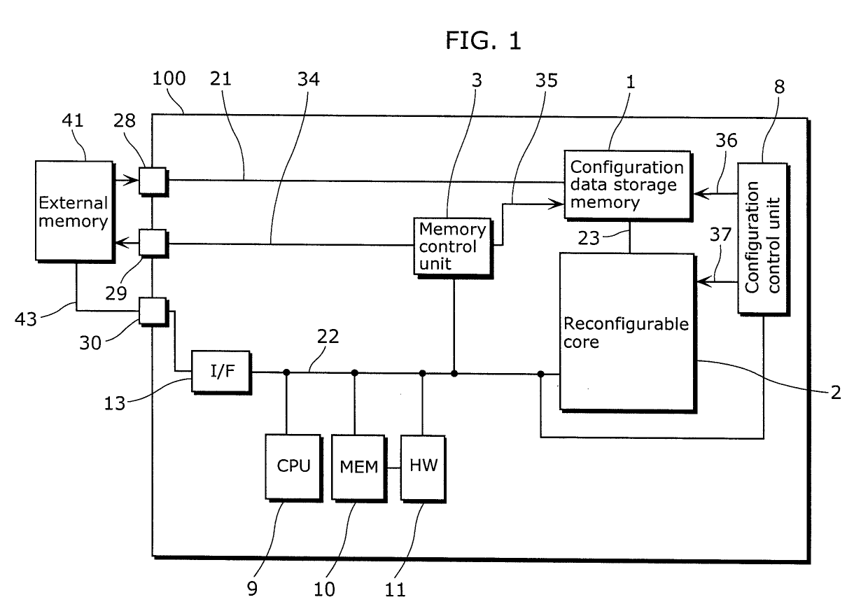

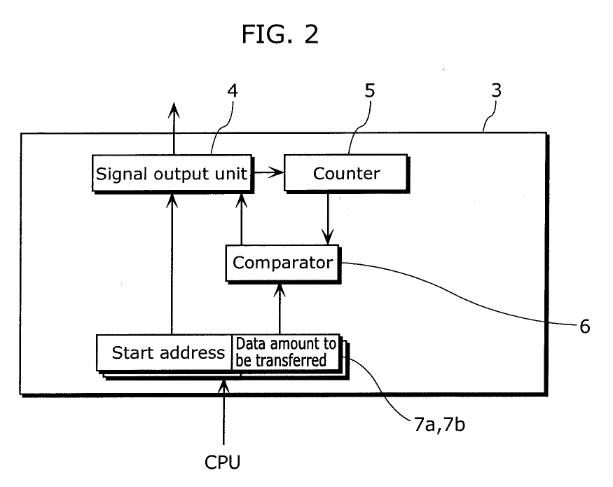

An LSI having a reconfigurable core according to a first embodiment of the present invention is described with reference to FIGS. 1 and 2. A description is first given for elements and their functions according to this embodiment. A specific example is then given so as to describe how the elements operate.

A description is given below for the configuration of an LSI 100 according to this embodiment.

FIG. 1 shows the overall configuration of the LSI 100.

Outside the LSI 100, an external memory 41 is provided so as to store a program for operating the LSI 100 and at least one configuration data. Inside the LSI 100, a configuration data storage memory 1 is provided so as to store configuration data transferred from the external memory 41 through an IO terminal 28 and a data transfer bus 21 dedicated to transfer configuration data.

The present invention is drastically different from the conventional technology in that the dedicated data transfer bus 21 is provided between the external memory 41 and the configuration data storage memory 1. The dedicated data transfer bus 21 allows configuration data to be transferred without the influence of another operation inside the LSI 100 such as the data transfer between a CPU 9, a data memory 10, and a dedicated hardware 11.

There is also provided a configuration control unit 8 so as to control the transfer of configuration data from the configuration data storage memory 1 to the reconfigurable core 2 and the storage of the configuration data therein. From the configuration control unit 8, the following two signals are outputted as appropriate under command of the CPU 9: a control signal 36 required when access is made to the configuration data storage memory 1 for read; and a control signal 37 required when configuration data is stored in a storage inside the reconfigurable core 2.

The reconfigurable core 2 reconnects the logic elements therein by the configuration data downloaded from the configuration data storage memory 1 through the dedicated data transfer bus 21 so as to change its function.

There is also provide a memory control unit 3 so as to control the operations of the external memory 41 and the configuration data storage memory 1 when data is fetched from the outside of the LSI 100. Specifically, the memory control unit 3, under command of the CPU 9, outputs a control signal 35 such as a chip select signal, a read signal, or an address signal, to the configuration data storage memory 1. The memory control unit 3 also outputs a control signal 34 such as a chip select signal, a read signal, or an address signal, to the external memory 41. The control signal 35 is inputted to the configuration data storage memory 1 through a bus inside the LSI 100. The control signal 34 is inputted to the external memory 41 through a bus inside the LSI 100 and then through an IO terminal 29.

FIG. 2 shows details of the configuration of the memory control unit 3.

The memory control unit 3 includes registers 7a and 7b. Under command of the CPU 9, information for taking configuration data from an area specified in the external memory 41 is set in the register 7a, and information for storing configuration data in an area specified in the configuration data storage memory 1 is set in the register 7b, as appropriate respectively.

The information set in the register 7a according to this embodiment means a start address for accessing an area specified in the external memory 41 and a value of an amount of configuration data to be transferred. The information set in the register 7b means a start address for accessing an area specified in the configuration data storage memory 1 and a value of an amount of configuration data to be transferred.

There is also provided a signal output unit 4 inside the memory control unit 3 so as to increment an address value by one based on the start address set in the register 7a or 7b, and then to output the address value to either the external memory 41 or the configuration data storage memory 1. The value of a counter 5 is also incremented by one every time the address value is outputted. In order to compare the value of the amount of configuration data to be transferred set in the register 7a or 7b with the value of the counter 5, and then to determine whether or not the values match, a comparator 6 is provided. The signal output unit 4 continues the increment/output of the address value and the increment of the value of the counter 5 until the two values match.

Referring again to FIG. 1, a subsequent description is given below.

There is provide a general-purpose bus 22 inside the LSI 100 so as to connect to the external memory 41 through an interface circuit 13, an IO terminal 30, and an external bus 43. Inside the LSI 100, a plurality of devices are provided which are connected to another device (hereinafter, the term “device” means a circuit block inside the LSI 100) through the general-purpose bus 22.

The CPU 9 controls the inside of the LSI 100 by executing the program read from the external memory 41 through the interface circuit 13, the IO terminal 30 and the general-purpose bus 22. Specifically, the CPU 9 instructs another device inside the LSI 100 to operate in a specific purpose such as setting a value for the register 7a or 7b of the memory control unit 3.

Under command of the CPU 9 received through the general-purpose bus 22, the dedicated hardware 11 executes processing on another device. For example, data is read from the data memory 10 through the dedicated bus between the dedicated hardware 11 and the data memory 10 for processing. The processed data is rewritten to the data memory 10 from the dedicated hardware 11. The CPU 9 detects that a predetermined process has completed and then instructs the data memory 10 to output the processed data to the outside of the LSI 100.

In the LSI 100 configured as above, an operational description is given for decoding of an encrypted JPEG image by way of example. The following is a brief outline of the operation. In a state in which the reconfigurable core 2 is being used for decrypting the encrypted JPEG image data, the configuration data for decoding the image data subsequently is stored in advance in the configuration data storage memory 1, by being transferred from the external memory 41 through the dedicated data transfer bus 21. The configuration data for decoding is then stored in the reconfigurable core 2 with the right timing of switching the functions of the reconfigurable core 2 from decryption to decoding. Details of the operation are given below.

<Step 1> Inside the LSI 100, an application program is executed by the CPU 9, the data memory 10, the dedicated hardware 11, the reconfigurable core 2 and the like in cooperation. In this embodiment, encrypted data is decrypted in the reconfigurable core.

<Step 2> The program stored in the external memory 41 directs the CPU 9 to fetch the configuration data for decoding compressed image data into the configuration data storage memory 1.

<Step 3> Based on the program, the CPU 9 instructs, through the general-purpose bus 22, the memory control unit 3 to control the external memory 41 and the configuration data storage memory 1. In both of the registers 7a and 7b, the following pieces of information are set: a memory start address to be referred to when configuration data is read out or written in; and an amount of configuration data to be transferred. In the memory control unit 3, signals including a chip select signal, a read signal, and an address signal are prepared as the information required for accessing the external memory 41 so as to read the configuration data for decoding.

<Step 4> Based on the information set in the registers 7a and 7b, the memory control unit 3 transfers a control signal 34 to the external memory 41 through the IO terminal 29. In this case, in order to read configuration data from an area specified in the external memory 41, the start address set in the register 7b is transferred as the address signal of the control signal 34.

<Step 5> Based on the address signal transferred to the external memory 41, the configuration data corresponding to the start address is read from the external memory 41. Every time the address signal is transferred to the external memory 41, the counter 5 in the memory control unit 3 is incremented, and the comparator 6 compares the counter value with the value of the amount of configuration data to be transferred set in the register 7a so as to determine whether or not the values match. If the values do not match, the address value of the register 7a is also incremented by the signal output unit 4, and the address of the data to be read subsequently is then set. Until the value of the counter 5 satisfies a termination condition (in this case, the counter value should match the data amount to be transferred set in the register 7a), the address value and the value of the counter 5 are incremented repeatedly while the configuration data corresponding to the address value is sequentially read from the external memory 41. The configuration data read out for decoding is fetched into the LSI 100 through the IO terminal 28.

<Step 6> The memory control unit 3 sends a control signal 35 to the configuration data storage memory 1 so that the configuration data which has been transferred from the external memory 41 onto the dedicated data transfer bus 21 might be fetched therein. In this case, in order to store the configuration data in an area specified in the configuration data storage memory 1, the start address set in the register 7b is transferred as the address signal of the control signal 35.

<Step 7> The configuration data is stored in the configuration data storage memory 1 through the dedicated data transfer bus 21 by the control signal 35. In this case, similarly to <Step 5>, with a mechanism including the counter 5, the comparator 6, and the like, the configuration data for decoding is sequentially stored in the area specified in the configuration data storage memory 1 until the termination condition (the value of the counter 5 should match the value of the amount of data to be transferred set in the register 7b) is satisfied.

As has been described above in <Step 3> to <Step 7>, in the configuration data transfer through the dedicated data transfer bus 21, the path from the external memory 41 through the IO terminal 28 and the dedicated data transfer bus 21 up to the configuration data storage memory 1 is allocated only for configuration data transfer. Therefore, the dedicated data transfer bus 21 and the general-purpose bus 22 are operable concurrently, thereby completing configuration data transfer constantly within a calculated time frame without the influence of the operations inside the LSI 100 including the reconfigurable core 2 during decrypting.

Next, a description is given for an operation in which the configuration data for decoding stored in the configuration data storage memory 1 is further stored in the reconfigurable core 2.

<Step 8> The CPU 9 starts the configuration control unit 8 at the same time the functions of the reconfigurable core 2 are switched from decryption to decoding.

<Step 9> The configuration control unit 8 sends a control signal 36 to the configuration data storage memory 1, and a control signal 37 to the reconfigurable core 2. Based on these control signals, the configuration data for decoding stored in the configuration data storage memory 1 is downloaded to the reconfigurable core 2 through a bus 23. The configuration data transfer, which means the data transfer between devices inside the LSI 100, is faster than a case in which configuration data is transferred sequentially from the outside of the LSI 100. Therefore, the functions are switched from decryption to decoding at a high speed.

<Step 10> As has been described above, the reconfigurable core 2 to which the configuration data for decoding is downloaded, starts decoding in response to the signal from the CPU 9.

The process from <Step 1> to <Step 10> transfers and then stores the configuration data for decoding to be executed subsequently to/in the configuration data storage memory 1 without the operational influence of the other devices inside the LSI 100 such as decryption in the reconfigurable core 2. For switching the functions of the reconfigurable core 2, therefore, smoother image reproduction and higher-speed download become possible compared to a case in which configuration data is read subsequently from the outside of the LSI 100.

In this embodiment, the overall wiring of the dedicated data transfer bus 21 may be passive, and a means which transmits a signal over long distance may be provided such as a buffer or a repeater.

If a dynamic reconfigurable core capable of changing its function dynamically is employed as the reconfigurable core 2, the transfer from the configuration data storage memory 1 to the reconfigurable core 2 becomes further faster (three orders of magnitude faster than an FPGA).

If a dual port memory is employed for the configuration data storage memory 1, it becomes possible to execute the following operations concurrently: the writing of configuration data in the configuration data storage memory 1 from the external memory 41; and the reading of configuration data from the configuration data storage memory 1 into the reconfigurable core 2. Therefore, such timings of writing/reading are relieved from restrictions, thereby switching the functions of the reconfigurable core 2 at a higher speed as a whole.

Although examples of the information to write/read configuration data include a start address and an amount of configuration data to be transferred in this embodiment, other forms of information including the combination of a start address and an end address are also available.

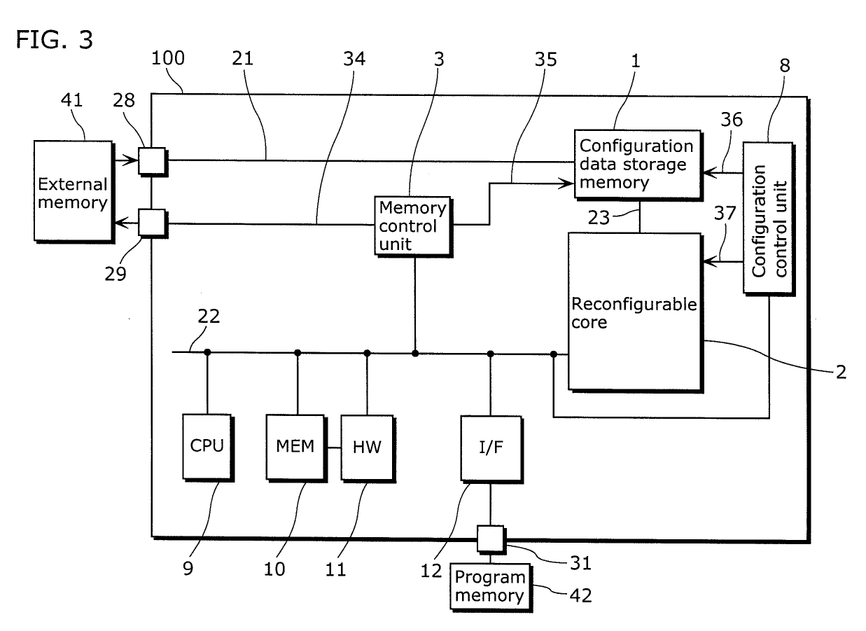

In this embodiment, a general-purpose memory which stores not only configuration data but also a program is employed for the external memory 41. However, the external memory 41 may be disposed as the memory dedicated to the configuration data for connecting to the inside of the LSI 100 only through the IO terminals 28 and 29. In this case, in order to operate the CPU 9, an extra program memory has to be provided outside the LSI 100, and a means which connects the extra program memory to the general-purpose bus 22 is required. For example, an interface circuit 12, an IO terminal 31, a program memory 42, and the like may be provided as shown in FIG. 3.

### (2) Second Embodiment

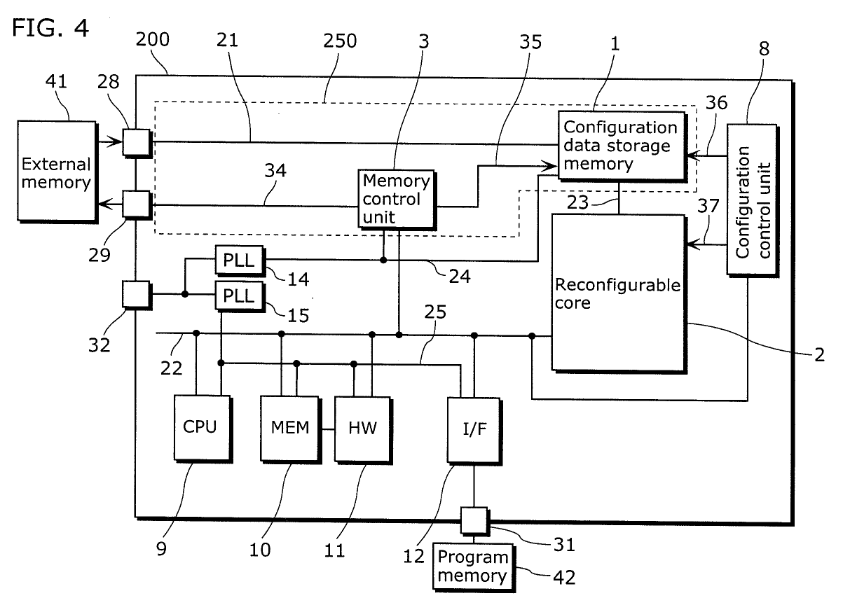

An LSI having a reconfigurable core according to a second embodiment of the invention is described with reference to FIG. 4. To begin with, a description is given for elements and their functions according to this embodiment. A specific example is then given for describing how the elements operate. Note that the description of the elements which have a similar function in the first embodiment is not repeated here. In this embodiment, the term “clock domain” is defined as a group of devices driven by a common clock frequency.

A description is given below for the configuration of an LSI 200 according to this embodiment.

FIG. 4 shows the overall configuration of the LSI 200.

A clock domain 250 defines an area which is operated by a clock independently of the other blocks inside the LSI 200. The clock domain 250 includes a plurality of devices involved in configuration data transfer such as a memory control unit 3, a configuration data storage memory 1, and a dedicated data transfer bus 21.

The clock domain 250 further includes a system for storing configuration data into the configuration data storage memory 1. The system is operable by a clock different from the clock for the other blocks owing to a clock line 24 dedicated thereto within the clock domain 250. Accordingly, it is possible to set the transfer rate of configuration data independently of the other blocks of the LSI 200. Specifically, the right clock frequency is provided for configuration data transfer consistently without the influence of the operations (at low speed or halted) of the other blocks. As has been described above, this embodiment is characterized in that the device group involved in configuration data transfer is defined as the clock domain 250 so that clock signals are given independently of the other blocks, thereby achieving high-speed data transfer.

There is provided a clock terminal 32 so as to send clock signals from the outside of the LSI 200 to the inside thereof. The clock signals sent from the clock terminal 32 are controlled in frequency by the following two PLLs: One is a PLL 14 which sets the frequency of clock signals to be supplied to the clock domain 250. Clock signals having the frequency set in the PLL 14 are supplied to each device within the clock domain 250 through the clock line 24. The other is a PLL 15 which sets the frequency of clock signals to be supplied to elements including the CPU 9, the data memory 10, and the dedicated hardware 11. Clock signals having the frequency set in the PLL 15 are supplied to all the blocks except the clock domain 250 through the clock line 25.

The interface circuit 12 enables data to be transferred to the outside of the LSI 200 through an IO terminal 31. There is also provided a program memory 42 so as to connect to the CPU 9 through the IO terminal 31, the interface circuit 12, and the general-purpose bus 22.

In the LSI 200 configured as above, an operational description is given for reproduction of an encrypted JPEG image. Configuration data transfer and the function switching of a reconfigurable core 2 are performed similarly to <Step 1> to <Step 10> according to the first embodiment. Only operations unique to the second embodiment are described below.

In the second embodiment, if it is desirable that the clock domain 250 is different from the other blocks in processing speed inside the LSI 200, the clock frequencies to be supplied to the clock domain 250 and to the other blocks are varied by the PLL 14 and the PLL 15, respectively.

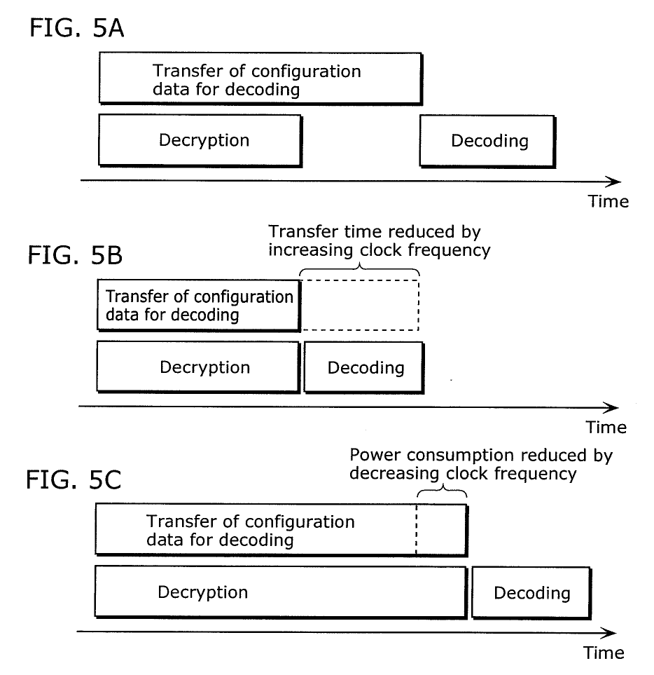

Let us take an example in which, if all the blocks inside the LSI 200 operate based on the frequency of the clock signals supplied from the outside of the LSI 200 through the clock terminal 32, the completion of configuration data transfer for the next decoding lags behind the completion of the decryption in the reconfigurable core 2 (FIG. 5A). In this case, the clock signals to be supplied to the clock domain 250 are converted so as to have a higher-speed operational frequency through the PLL 14.

Since this performs processing at a higher speed than in the other blocks within the clock domain 250, control becomes possible so that the storage of configuration data for decoding is completed by the time when the decryption completes (FIG. 5B). Furthermore, no influence is exerted on the operations of the devices outside the clock domain 250. Therefore, losses due to the function switching of the reconfigurable core 2 are reduced, thereby achieving a higher-speed image reproduction.

In contrast, if a time interval is long enough until the functions of the reconfigurable core 2 are switched, the PLL 14 reduces the speed of the clock signals to be given to the clock domain 250 as far as the function switching for decoding arrives in time (FIG. 5C), thereby preventing wasteful power consumption.

As has been described above, the clock domain 250 and the other blocks are controlled by sequences of clock signals having different frequencies, thereby improving the operational efficiency of the overall LSI 200.

While this embodiment relates to the case in which the PLL 14 converts the frequency of the clock signals to the clock domain 250, the PLL 15 may control the frequency of the clock signals to be given to the other blocks concurrently.

In this case, the difference between clock domains may derive from the difference in PLL which supplies clock signals to each clock domain, or the frequency-division ratios of the dividers disposed immediately before each of the clock domains may be controlled independently.

Each clock domain may further include a divider so as to set the right clock frequency for each device. Specifically, a divider may be provided before the interface circuit 12 so as to further decrease the clock frequency to be given to the interface circuit 12.

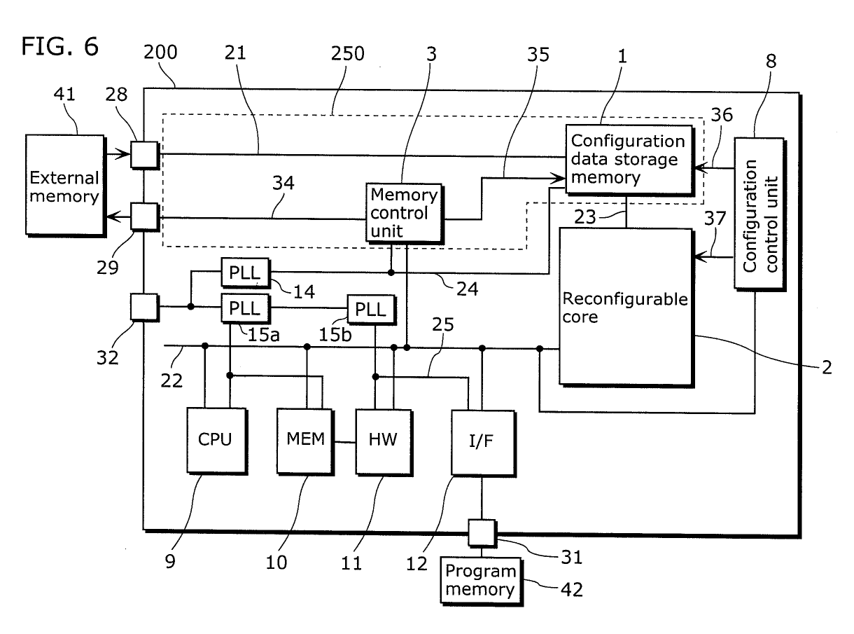

In addition, a plurality of PLLs may be provided for a single clock domain so as to set the right clock frequency for each device. Specifically, as shown in FIG. 6, a PLL 15a and a PLL 15b may generate two sequences of clock signals with frequencies controllable independently of each other, and the two sequences of clock signals may be transferred to different devices through clock lines independently of each other.

The effectiveness of the present invention does not decline even if the clock domain 250 further includes another block for configuration data transfer (other than described in this embodiment).

The effectiveness of the present invention also does not decline, regardless of whether a single clock domain or a plurality thereof are provided outside the clock domain 250.

In this embodiment, the bus which connects the external memory 41 to the configuration data storage memory 1 does not necessarily have to be a bus dedicated to configuration data transfer. A general-purpose bus may be employed for this configuration.

### (3) Third Embodiment

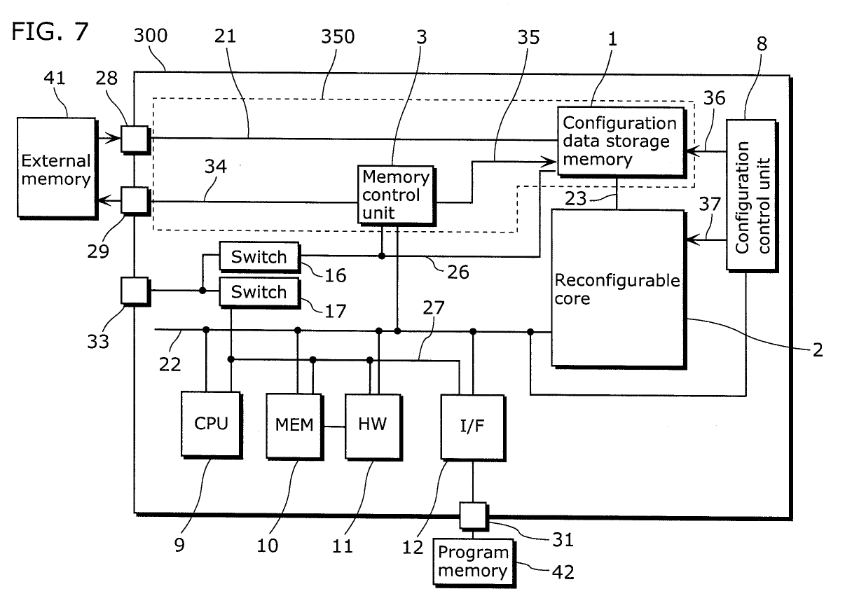

An LSI having a reconfigurable core according to a third embodiment of the invention is described with reference to FIG. 7. To begin with, a description is given for elements and their functions according to this embodiment. A specific example is then given for describing how the elements operate. Note that the description of the elements which have a similar function in the first embodiment is not repeated here.

In this embodiment, the term “power domain” is defined as a group of devices driven by a voltage applied through a common power line.

A description is given below for the configuration of an LSI 300 according to this embodiment.

FIG. 7 shows the overall configuration of the LSI 300.

A power domain 350 defines an area to which power is supplied independently of the other blocks inside the LSI 300. The power domain 350 includes a plurality of devices involved in configuration data transfer such as a memory control unit 3, a configuration data storage memory 1, and a dedicated data transfer bus 21.

The power domain 350 further includes a system for storing configuration data into the configuration data storage memory 1. Power supply to the system is controllable independently of the other blocks owing to a power line 26 dedicated to the system within the power domain 350. Accordingly, it is possible to transfer configuration data without the influence of the power control over the other blocks (power-on, power-off, or the like). As has been described above, this embodiment is characterized in that a device group involved in configuration data transfer is defined as the power domain 350 so as to control power supply independently of the other blocks, thereby achieving efficient configuration data transfer.

There is provided a power terminal 33 so as to supply power from the outside of the LSI 300 to the inside thereof. In order to set the power-on, power-off, or the like of the power supplied from the power terminal 33, the following two power switches are provided: One is a power switch 16 which supplies power to each device within the power domain 350. When the power switch 16 is turned on, power is supplied to the elements within the power domain 350 including the memory control unit 3 and the configuration data storage memory 1, through the power line 26. The other is a power switch 17 which supplies power to all the blocks except the power domain 350. When the power switch 17 is turned on, power is supplied to the blocks including the CPU 9, the data memory 10, the dedicated hardware 11, and the like, through the power line 27.

The interface circuit 12 enables data to be transferred to the outside of the LSI 300 through an IO terminal 31. There is also provided a program memory 42 so as to connect to the CPU 9 through the IO terminal 31, the interface circuit 12, and the general-purpose bus 22.

In the LSI 300 configured as above, a description is given for the operation under power-saving mode. Configuration data transfer and the function switching of a reconfigurable core 2 are performed similarly to <Step 1> to <Step 10> according to the first embodiment. Only operations unique to the third embodiment of the invention are described below.

In the third embodiment, if it is desirable that power to the power domain 350 is turned on, turned off or the like independently of the power to the other blocks inside the LSI 300, the power switches 16 and 17 control power so as to be supplied to the power domain 350 and the other blocks, respectively.

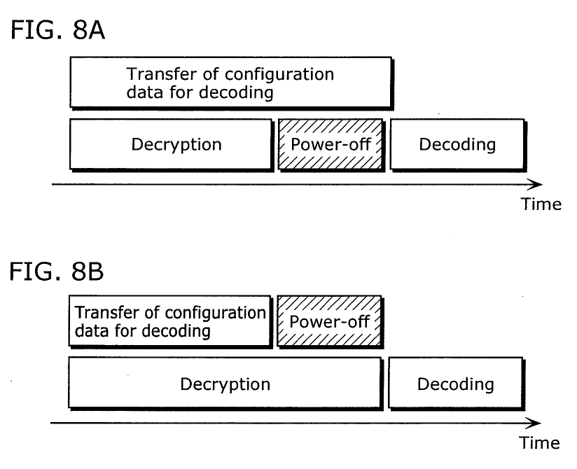

Let us take an example in which, if power-saving mode such as standby is requested from the outside of the LSI 300, the power switch 17 turns off the power to be supplied to all the blocks except the power domain 350. On the other hand, the power switch 16 continuously supplies power to the power domain 350 so that required configuration data is transferred to the inside of the LSI 300 from an external memory 41 and then kept ready until the power-saving mode is discontinued followed by a command for the subsequent processing (for example, to decode JPEG image data) (FIG. 8A). As a result, at the point when the power-saving mode is discontinued so as to restart the power supply from the power switch 17 thereby starting the decoding, the configuration data for decoding has already arrived inside the LSI 300. This allows the functions of the reconfigurable core 2 to be switched at a higher speed.

In contrast, the transfer of the configuration data for decoding has completed before the completion of decryption, the power supply from the power switch 16 may be turned off after the configuration data transfer completion until the decryption completion (FIG. 8B). This reduces wasteful power consumption within the power domain 350.

As has been described above, the power supplies to the power domain 350 and to the other blocks are controlled independently of each other, thereby improving the operational efficiency of the overall LSI 300.

In order to control the power supply to each block, there may be provided an independent power switch within the LSI 300 as described in this embodiment. There may also be provided a plurality of independent terminals for power supply on the border between the outside and the inside of the LSI 300.

The power domain 350 may further include the reconfigurable core 2. In this case, while the power to the other blocks is turned off, the steps up to function switching for decoding have completed in the reconfigurable core 2. Accordingly, it is possible that decoding is performed immediately when the LSI 300 starts.

In this embodiment, the bus which connects the external memory 41 to the configuration data storage memory 1 does not necessarily have to be a bus dedicated to configuration data transfer. A general-purpose bus may be employed for this configuration.

### (4) Fourth Embodiment

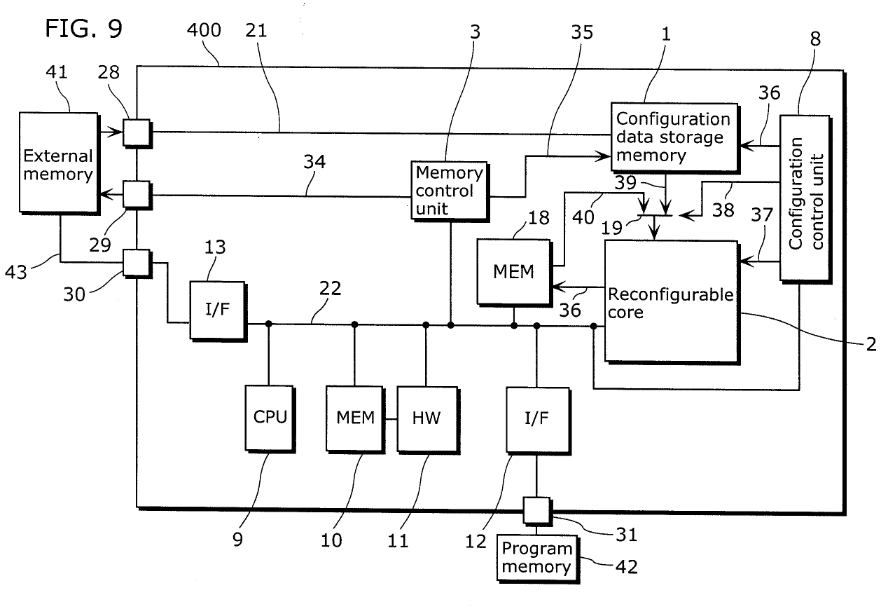

An LSI having a reconfigurable core according to a fourth embodiment of the invention is described with reference to FIG. 9. To begin with, a description is given for elements and their functions according to this embodiment. A specific example is then given for describing how the elements operate. Note that the description of the elements which have a similar function in the first embodiment is not repeated here.

A description is given below for the configuration of an LSI 400 according to this embodiment of the invention.

FIG. 9 shows the overall configuration of the LSI 400.

Inside the LSI 400, a second data memory 18 for general-purpose use, which is different from a configuration data storage memory 1, is connected to a general-purpose bus 22. The second data memory 18 is available as an application memory which a CPU 9 or a reconfigurable core 2 uses to store data for an application program.

This embodiment is characterized in that a plurality of data memories are provided inside the LSI 400 so as to store configuration data, thereby achieving high-speed function switching of the reconfigurable core 2.

In the configuration data storage memory 1, first configuration data, transferred from an external memory 41 through a dedicated data transfer bus 21, is stored. On the other hand, in a data memory 18 inside the LSI 400, for general-purpose use, not only data for an application program is stored; second configuration data, transferred from the external memory 41 through an IO terminal 30 and the general-purpose bus 22, is also stored.

The first configuration data is outputted from the configuration data storage memory 1 as output data 39. On the other hand, the second configuration data is outputted from the second data memory 18 as output data 40.

Both output data 39 and 40 are inputted to a multiplexer 19. The multiplexer 19 then selects either of the output data 39 or the output data 40 so as to transfer the selected data to the reconfigurable core 2. Which configuration data should be selected is determined by a select signal 38 for the multiplexer sent from the configuration control unit 8.

From the configuration control unit 8, in addition to the select signal 38, the following two signals are outputted as appropriate. One is a control signal 36 required for read access to the configuration data storage memory 1 or the second data memory 18. The other is a control signal 37 required for storing configuration data in a storage inside the reconfigurable core 2.

In the LSI 400 configured as above, an operational description is given for reproduction of an encrypted JPEG image. A brief outline of the operation is that, configuration data for decrypting the image data stored in the configuration data storage memory 1, or configuration data for decoding the image data stored in the second data memory 18 is downloaded to the reconfigurable core 2. Details of the operation are given below.

<Step 41> Inside the LSI 400, an application program is executed by the CPU 9, the data memory 10, the dedicated hardware 11, the reconfigurable core 2, and the like in cooperation.

<Step 42> The program stored in the external memory 41 directs the CPU 9 to fetch the configuration data for decrypting encrypted image data into the configuration data storage memory 1.

<Step 43> Based on the program, the CPU 9 instructs, through the general-purpose bus 22, the memory control unit 3 to control the external memory 41 and the configuration data storage memory 1. In registers 7a and 7b, a start address in the memory for reading/writing configuration data are set respectively. An amount of configuration data to be transferred is also set therein. In the memory control unit 3, signals including a chip select signal, a read signal, and an address signal are prepared as the information required for accessing the external memory 41 so as to read the configuration data for decryption.

<Step 44> Based on the information set in the registers 7a and 7b, the memory control unit 3 transfers a control signal 34 to the external memory 41 through the IO terminal 29. In this case, in order to read configuration data from an area specified in the external memory 41, the start address set in the register 7a is transferred as the address signal of the control signal 34.

<Step 45> Based on the address signal transferred to the external memory 41, the configuration data corresponding to the start address is read from the external memory 41. Every time the address signal is transferred to the external memory 41, a counter 5 in the memory control unit 3 is incremented, and a comparator 6 compares the counter value with the value of the amount of configuration data to be transferred set in the register 7a so as to determine whether or not the values match. If the values do not match, the address value of the register 7a is also incremented by the signal output unit 4, and the address of the data to be read subsequently is then set. Until the value of the counter 5 satisfies an termination condition (in this case, the counter value should match the data amount to be transferred set in the register 7a), the address value and the value of the counter 5 are incremented repeatedly while the configuration data corresponding to the address value is sequentially read from the external memory 41. The configuration data read out for decryption is fetched in the LSI 400 through the IO terminal 28.

<Step 46> The memory control unit 3 sends a control signal 35 to the configuration data storage memory 1 so that the configuration data which has been transferred from the external memory 41 onto the dedicated data transfer bus 21 might be fetched therein. In this case, in order to store the configuration data in an area specified in the configuration data storage memory 1, the start address set in the register 7b is transferred as the address signal of the control signal 35.

<Step 47> The configuration data is stored into the configuration data storage memory 1 through the dedicated data transfer bus 21 by the control signal 35. In this case, similarly to <Step 45>, with a mechanism including the counter 5, the comparator 6, and the like, the configuration data for decoding is sequentially stored in the area specified in the configuration data storage memory 1 until the termination condition (the value of the counter 5 should match the value of the amount of data to be transferred set in the register 7b) is satisfied.

<Step 48> From the external memory 41 outside the LSI 400, the configuration data for decoding compressed image data is fetched through the IO terminal 30 and the interface circuit 13 so that the configuration data is stored into the second data memory 18 through the general-purpose bus 22.

<Step 49> In the configuration data storage memory 1, the configuration data for decryption is stored. In the second data memory 18, the configuration data for decoding is stored.

<Step 50> With the timing of switching the functions of the reconfigurable core 2, the CPU 9 starts the configuration control unit 8. Simultaneously, a signal is sent to specify which configuration data is used, for decryption or for decoding. Based on the specification, the configuration control unit 8 outputs a select signal 38 for the multiplexer.

<Step 51> If the configuration data for decryption is to be used, the multiplexer 19 selects output data 39 from the configuration data storage memory 1 based on the select signal 38. In contrast, if the configuration data for decoding is to be used, the multiplexer 19 selects output data 40 from the second data memory 18 based on the select signal 38.

In this example, decoding is impossible before decrypting encrypted image data. Therefore, the configuration data for decryption is first selected.

The configuration data for decryption selected in <Step 52> and <Step 51> is downloaded to the reconfigurable core 2. In this case, the control signal 36 directs the configuration data to be read from the configuration data storage memory 1 and the control signal 37 directs the configuration data to be written in the reconfigurable core 2 at the same time.

As has been described above, plural pieces of configuration data are kept ready inside the LSI 400. Therefore, it is possible to switch the functions of the reconfigurable core 2 at a high speed using either of the configuration data stored in the configuration data storage memory 1 or the configuration data stored in the second data memory 18.

The second data memory 18 according to this embodiment, which is for general-purpose use, is available not only for storing configuration data but also for holding the data for another process performed inside the LSI 400. These data may be held concurrently with the configuration data.

The storage of configuration data in the second data memory 18 shown in <Step 48> according to this embodiment, as long as it arrives in time to switch the functions of the reconfigurable core 2, may be performed concurrently with or before the storage of configuration data in the configuration data storage memory 1.

This embodiment, which relates to the case in which two pieces of configuration data are handled, is expandable to any number of configuration data pieces depending on the capacity of an available memory. This embodiment is also expandable to various types of memory. In this case, the number of input signals to the multiplexer 19 and the logic of a select signal are changed accordingly.

Although this embodiment relates to the case in which the same control signal 36 is generated for access to two types of memory, a plurality of control signals may be generated according to the available memory types. In this case, the configuration control unit 8 includes a required number of circuits for controlling memory access accordingly.

If it does not matter if configuration data is transferred from the external memory 41 to the second data memory 18 of the LSI 400 at a very low speed, a configuration may be such that configuration data is inputted directly to the multiplexer 19 not through the second data memory 18, but through the IO terminal 30 and the interface circuit 13. In this case, the interface circuit 13 has to be set to send the data to the multiplexer 19 in an appropriate addressing.

The second data memory 18 is not used depending on application program. For example, if the amount of configuration data to be transferred is so small that the configuration data storage memory 1 has a capacity enough to execute a given application program, it does not matter without the use of the second data memory 18.

In this embodiment, the bus which connects the external memory 41 to the configuration data storage memory 1 does not necessarily have to be a bus dedicated to configuration data transfer. A general-purpose bus may be employed for this configuration.

### (5) Fifth Embodiment

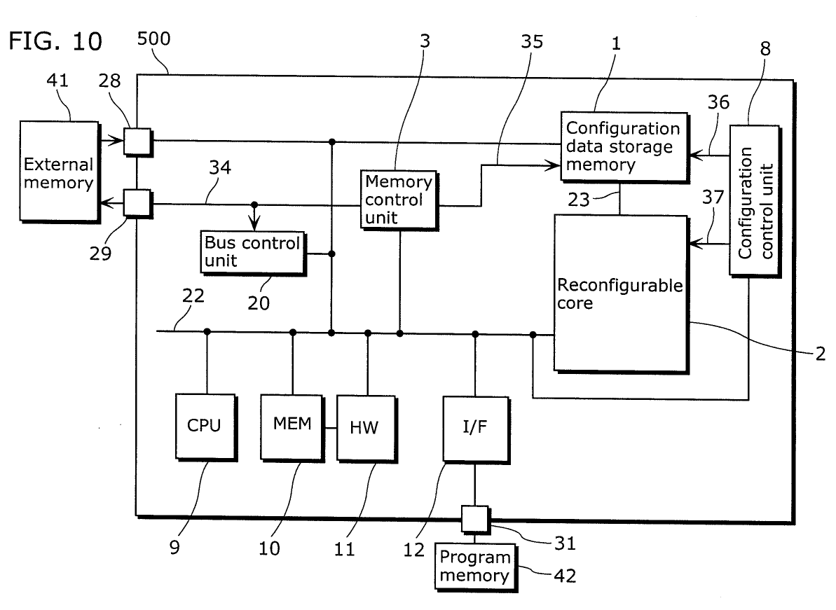

An LSI having a reconfigurable core according to a fifth embodiment of the invention is described with reference to FIG. 10. To begin with, a description is given for elements and their functions according to this embodiment. A specific example is then given for describing how the elements operate. Note that the description of the elements which have a similar function in the first embodiment is not repeated here.

A description is given below for the configuration of an LSI 500 according to this embodiment.

FIG. 10 shows the overall configuration of the LSI 500.

There is provided a bus control unit 20 so as to control each data transfer by the plurality of devices connected to the general-purpose bus 22, based on the priorities set in the bus control unit 20 and the signal from the memory control unit 3. That is, the bus control unit 20 is a bus arbiter which controls the general-purpose bus 22 to transfer data in the order of priorities, by giving the right to transfer data to each device according to the priority order of each device, thereby achieving efficient data transfer.

In this embodiment, there is no data bus which connects only the IO terminal 28 and the configuration data storage memory 1. It is also through the general-purpose bus 22 that configuration data is transferred from the external memory 41 to the configuration data storage memory 1. Specifically, the general-purpose bus 22 according to this embodiment includes the aforementioned dedicated data transfer bus 21.

According to this embodiment, when a configuration data transfer is requested, the bus control unit 20 temporarily stops all the data transfers except the configuration data transfer, including the data transfer between the CPU 9 and the data memory 10 through the general-purpose bus 22. The bus bandwidth of the general-purpose bus 22 is reserved only for configuration data transfer at least between the IO terminal 28 and the configuration data storage memory 1.

As has been described above, this embodiment of is characterized in that the bus control unit 20 controls the data transfer on the general-purpose bus 22 so that the bus 22 is dedicated to configuration data transfer at least between the IO terminal 28 and the configuration data storage memory 1, thereby achieving a high-speed configuration data transfer.

In the LSI 500 configured as above, an operational description is given for reproduction of an encrypted JPEG image by way of example. Configuration data transfer and the function switching of a reconfigurable core 2 are performed similarly to <Step 1> to <Step 10> according to the first embodiment. Only operations unique to the fifth embodiment are described below. Note that the fifth embodiment is different from the first embodiment in that no data transfer bus 21 dedicated to configuration data transfer is provided. That is, the process is required in which the bus control unit 20 temporarily converts the general-purpose bus 22 into a bus dedicated to configuration data transfer. Specifically, the following two more steps are added between <Step 4> and <Step 5> according to the first embodiment.

<Step 61> A control signal 34 is also transferred to the bus control unit 20 in synchronism with <Step 4>.

<Step 62> In order to transfer the control signal 34 from the memory control unit 3 to the external memory 41, and further to transfer configuration data from the external memory 41 to the inside of the LSI 500, with top priority, the bus control unit 20, when receiving the control signal 34, temporarily stops all the data transfers except the above two transfers on the general-purpose bus 22 so as to reserve the bus bandwidth therefor.

<Step 62> is a state in which a virtual bus dedicated to configuration data transfer is provided under the control of the bus control unit 20. As has been described above, the transfer using the general-purpose bus 22 inside the LSI 500, between the CPU 9, the data memory 10, and the dedicated hardware 11 are in a wait state, thereby completing the transfer from the external memory 41 to the configuration data storage memory 1 within a calculated time frame consistently without the influence of the data transfer in the other blocks.

The bus control unit 20, which has been defined as the bus arbiter for the general-purpose bus 22, may also be provided as a bus bridge which logically connects/disconnects at intervals a first section connecting the IO terminal 28 and the configuration data storage memory 1 on the general-purpose bus 22, and a second section including the rest. In this case, the bus control unit 20 disconnects the first section and the second section on the general-purpose bus 22 logically so as to control the general-purpose bus 22, so that, for example, data is transferred between the CPU 9 and the data memory 10 in the second section concurrently with the configuration data transfer in the first section.

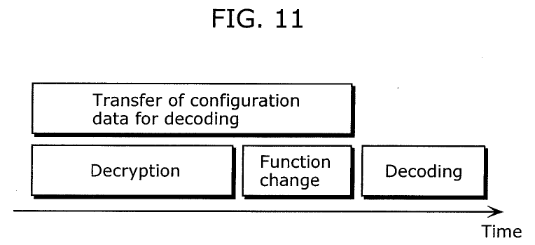

If a dual port memory is employed as the configuration data storage memory 1, there is no timing restraint on the data transfer for writing through the general-purpose bus 22 nor the data transfer for reading (function change) through the bus 23. It is possible to perform both processes concurrently, thereby achieving a high speed switching of the reconfigurable core functions (FIG. 11).

Although the present invention has been described with respect to the five embodiments, the embodiments do not necessarily have to be carried out independently; a combination thereof may be made therein without departing from the spirit and scope of the present invention. For example, the clock domain according to the second embodiment and the power domain according to the third embodiment may be employed in combination.

Note that the operations according to the above embodiments are shown by way of examples. It goes without saying that various types of operations are applicable to the present invention.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The programmable logic device according to the present invention is applicable to an LSI having a reconfigurable core so as to achieve both versatility and high performance successfully. The present invention can be useful in all fields where application to an LSI system is expected.

1. A programmable logic device comprising:
a configuration data storage memory which stores configuration data transferred from outside of said programmable logic device;
a reconfigurable core which changes its function according to the configuration data stored in said configuration data storage memory;
at least one IO terminal which transfers data from the outside of said programmable logic device; and
a data transfer bus which connects said IO terminal with said configuration data storage memory, and which is dedicated to configuration data transfer.

2. The programmable logic device according to claim 1, further comprising:
a CPU;
a data memory which stores application data which is different from the configuration data;
an interface circuit which transfers data from the outside of said programmable logic device; and
a general-purpose bus which connects said CPU, said data memory, and said interface circuit together, and which is operable concurrently with said data transfer bus.

3. The programmable logic device according to claim 1,
wherein a buffer which amplifies signals is provided in said data transfer bus.

4. The programmable logic device according to claim 1,
wherein said configuration data storage memory includes a multiport memory allowing at least two simultaneous accesses.

5. The programmable logic device according to claim 1, further comprising:
a CPU;
a data memory which stores application data which is different from the configuration data;
an interface circuit which transfers data from the outside of said programmable logic device;
a general-purpose bus which connects said CPU, said data memory, and said interface circuit together;
a memory control block operable to control access to said configuration data storage memory;
a first clock line which supplies clock signals to each of said general-purpose bus, said CPU, said data memory, and said interface circuit;
a second clock line which is different from said first clock line, and which supplies clock signals to both of said configuration data storage memory and said memory control block.

6. The programmable logic device according to claim 5,
wherein said first clock line is a clock line group made up of two or more independent clock lines.

7. The programmable logic device according to claim 5,
wherein a frequency of the clock signals supplied from said first clock line is controllable independently of a frequency of the clock signals supplied from said second clock line.

8. The programmable logic device according to claim 5,
wherein said second clock line is connected exclusively to said configuration data storage memory and said memory control block.

9. The programmable logic device according to claim 7, further comprising:
a first clock generation circuit which supplies the first clock signals to said first clock line; and
a second clock generation circuit which is different from said first clock generation circuit, and which supplies the second clock signals to said second clock line.

10. The programmable logic device according to claim 9,
wherein said first clock generation circuit and said second clock generation circuit each include a PLL circuit.

11. The programmable logic device according to claim 1, further comprising:
a CPU;
a data memory which stores data which is different from the configuration data;
an interface circuit which transfers data from the outside of said programmable logic device;
a general-purpose bus which connects said CPU, said data memory, and said interface circuit together;
a memory control block operable to control access to said configuration data storage memory;
a first power line which supplies power to said general-purpose bus, said CPU connected to said general-purpose bus, said data memory, and said interface circuit; and
a second power line which is different from said first power line, and which supplies power to said configuration data storage memory and said memory control block.

12. The programmable logic device according to claim 11,
wherein said second power line further supplies power to said reconfigurable core.

13. The programmable logic device according to claim 11,
wherein power-on and power-off of said first power line are controllable independently of power-on and power-off of said second power line.

14. The programmable logic device according to claim 11,
wherein said first power line and said second power line each have a switch, and the switches are controllable independently of each other.

15. The programmable logic device according to claim 1, further comprising:
a CPU;
an application data storage memory which is different from said configuration data storage memory, and which stores application data and another configuration data, both of which are different from the configuration data, the application data being data to be accessed by said CPU or said reconfigurable core, and the another configuration data being data for changing the function of said reconfigurable core; and
a connection switching unit operable to switch connection of said reconfigurable core either to said configuration data storage memory or to said application data storage memory.

16. The programmable logic device according to claim 1, further comprising:
a CPU; and
a data memory which stores application data which is different from the configuration data,
wherein said data transfer bus connects said IO terminal, said configuration data storage memory, said CPU, and said data memory together, and
said programmable logic device further comprises a bus control unit operable to control said data transfer bus so that said data transfer bus is dedicated to configuration data transfer at least between said IO terminal and said configuration data storage memory so as to transfer configuration data therebetween when the configuration data transfer is requested.

17. The programmable logic device according to claim 16,
wherein said bus control unit is operable to control said data transfer bus so as to transfer the application data between said CPU and said data memory concurrently with a transfer of the configuration data between said IO terminal and said configuration data storage memory.

18. An LSI system comprising:
the programmable logic device according to claim 1; and
an external memory device which is separated from the programmable logic device, and which stores configuration data to be transferred to the programmable logic device.
